(19) United States
(12) Patent Application Publication
(10) Pub. No.: US 2006/0106674 A1
(43) Pub. Date: May 18, 2006

(54) Mobile shopping method and application

(75) Inventor: Alex Muller, New York, NY (US)

Correspondence Address: GOTTLIEB RACKMAN & REISMAN PC, 270 MADISON AVENUE, 8TH FLOOR, NEW YORK, NY, 100160601, US

(73) Assignee: GPSHOPPER, Inc.

(21) Appl. No.: 11/059,204

(22) Filed: Feb. 16, 2005

Related U.S. Application Data
(60) Provisional application No. 60/628,279, filed on Nov. 16, 2004.

(51) Int. Cl. G06Q 30/00

(52) U.S. Cl. 705/14

(57) ABSTRACT

A system and method for crediting fees and commissions for the use by customers of mobile phones to search for product information directly from merchants or indirectly through product information aggregators. Further it provides for crediting fees and commissions for sending product identification to other customer's mobile phones. It supports third party use of the system to distribute specific sets of product instances accessible by users of a private label system.

### This application claims priority of Provisional Patent Application Ser. No. 60/628,279, filed Nov. 16, 2004.

### FIELD OF THE INVENTION

This invention relates to a system and method for crediting fees and commissions for the use by customers of mobile phones to search for product information directly from merchants or indirectly through product information aggregators. Further it provides for crediting fees and commissions for sending product identification to other customer's mobile phones.

### BACKGROUND OF THE INVENTION

Withe the explosion of use of the internet virtually every merchant for goods is providing product information on web pages and in many cases providing computerized shopping carts through which its products may be purchased. Thus systems are in place for a person having a computer with access to the internet is able to obtain product information and make on-line purchases. To facilitate this access there are search engines available by computer to locate desired products and/or merchants and advertising material providing links to merchant web pages.

At the same time, the use of mobile phones capable of displaying graphic information has become ubiquitous. It would be desirable to enable shoppers having mobile phones to locate available products and either refine their shopping choices or to complete purchase directly through use of the mobile phone. Mobile phones, however, are not friendly to receiving ads pushed at them and are not adapted to contain sophisticated search engines for locating desired products.

Some attempts at such systems have been made.

U.S. Pat. No. 6,587,835 entitled “Shopping Assistant with Handheld Computing Device” provides a system whereby a merchant having several stores monitors a user's location within a particular store and displays promotional material based on the user's location.

US patent application 2002/0002504 entitled “Mobile Shopping Assistant System and Device” provides a system coupled to a global positioning system. A mobile device comprising an optical scanner and a GPS scans a bar code of a product. The information from the scanner and the GPS cause a price and discount server to transmit back price and location information for similar products.

U.S. Pat. No. 6,714,797 entitled “System and Method for the Transfer of Digital Data to a Mobile Device” provides a program for ordering, paying for and downloading digital products to a mobile device. It uses its own short range transceivers at hotspot network locations to download large amounts of digital data without incurring telephone or cellular phone charges.

U.S. Pat. No. 6,615,179 entitled “Data Distribution Network and Method of Use” provides for the dissemination of data from a central computer to hand-held computers.

US patent application 2003/0061110 entitled “Location Based Services Virtual Bookmarking” provides a data store of products on display in a retail space that a user can notate with the physical location of the products so as to be able to return to those products either physically or later by use of a networked computer.

US patent application 2002/0174025 entitled “Method and System for Providing Targeted advertising and Personalized Customer Services” provides targeted advertising in response to preference information from a wireless communication device.

US patent application 2004/0181461 entitled “Multi-Modal Sales Applications” provides product information to the mobile electronic device of a shopper in a store such as purchase lists and best routes through the store during shopping.

US patent application 2004/0148226 entitled “Method and Apparatus for Electronic Product Information and Business Transactions” provides a shopping aid that a customer may consult to receive current and accurate information about a product and other compatible products and services.

US patent application 2004/0015560 entitled “Information Providing Method and Information Providing Device” provides a device for storing information in contactless integrated circuit cards.

US patent application 2004/0014454 entitled “Wireless Data System” provides a way for a user to request product information and authorize the purchase of a product.

US patent application 2003/0120745 entitled “Information Receiving System and Information Receiving Terminal” provides information on a cellular phone about products, by having the phone activate a transponder in a sales article that responds to the presence of the phone by providing information using the energy from the mobile device's RF signal.

US patent application 2003/0229678 entitled “System and Method for Processing Wireless Data” allows a portable electronic device that is capable of transmitting bar codes to an information center to receive back product information corresponding to the bar code.

US patent application 2002/0129119 entitled “Information Distribution Device and Information Distribution Method” provides a system for distributing information to devices whose addresses are stored on a server.

What is needed is a system that provides a user with information from many different and potentially competing sources of products. In particular what is needed is a system that encourages the maintenance of such a system by provided a method for the compensation of the provider and maintainer of the system by having a system of rewards that correspond to the successful use of the system by the customer either to make a purchase or to indicate interest by inquiring into the products whose information the system makes available in a convenient format and embodiment.

### BRIEF DESCRIPTION OF THE INVENTION

The invention is embodied in a program running on web-enabled cell phones to access a merchant's product information directly from the merchant or indirectly through a product information aggregator and affiliate networks. Product information will be displayed in a proprietary format, which is optimized for cellular phones. The number keys will support navigational and data entry to let the user access functions, such as “browse for product by category” or “search product name or model number”. The application will include features to optimize the user experience such as “auto fill” product names and easy to navigate interfaces. The application will take advantage of embedded features in the operating systems of the cellular phone, such as Location Based Services (LBS Java API) for locating of the end-user's position with respect to available retail locations, or capturing the user's cell-phone number for registering the identity of the user making the product inquiry, or accessing the users' phone book when the user is choosing to send identified products to friends and family. Lastly the application will use other capabilities inherent in some phones such as digital cameras, wifi(802.11X) and/or Blue-Tooth to identify products and retrieve product information.

The making of a product inquiry will be registered on server component of the application. All communication between the application on the cell phone and the Internet will be filtered through the server application, which sits in a data center. It acts as a proxy capturing and filtering the user and the product information. Additionally, it will trigger the actual clicks with the Affiliate Networks, Product Information Aggregators or the Merchants. A click is the use of a link to reach information on the merchants' web site directly or via proxy (such as web-service call). The merchant would then pay a sales commission or on a per click {“Product Inquiry” basis, directly or indirectly through Affiliate Networks, to the supplier of the program based on the commission amount offered through their “Affiliate Network”. The commission is granted to the last “information request” prior to the purchase even if the purchase was not made online, as long as the commissioning entity (Merchant or Affiliate Network) supported “Offline Tracking” (which is becoming a market standard in the coming months). Or, in the case of Affiliate Networks and Merchants, who do not support “Offline Tracking” per Product Inquiry fee will be charged. The amounts of the commissions or payments per Product Inquiries will be negotiated between our organization and the merchants. Payments on a per click or per “Product Inquiry” do not require “offline tracking” infrastructure.

An additional feature allows a user to send a product and location identifier also termed a product instance (for which the user could make product inquiry, which would count as a click with the Merchants and/or Networks) to another phone with the compatible application, about a product. If the receiver does not have the application installed on his cellphone, the user will receive an SMS message, which will identify instructions on downloading the application to his cell phone, at which point the product will be automatically ready for viewing in the application's shopping list. FIG. 4 describes the steps for sending a product instance to another shopper and the SMS messaging feature.

If the receiver of the product identifier retrieves the product information and opens it or a per Product Inquiry fee will be charged or a commission (if a purchase is made and Offline Tracking is supported). For purposes of this patent, both are referred to as a commission.

A preferred embodiment of the application consists of 2 distinct components; Client application residing on the cell phone written in commonly used languages for cell phones, such as Java 2.0 Micro Edition (J2ME) and BREW (Binary Runtime Environment for Windows) and a server application running a language such as Java 2.0 Enterprise Edition (J2ME).

The client application, installed on the user's cellular phone, assists and enhances the user's real world shopping experience. The user will be able to find available products in his neighborhood, locate the store, receive additional product details, store the products in a personal shopping list and share/send these product with other users. The client application performs these functions in conjunction with a server application that tracks and stores client's activity, as well as performs a “middle ware” translation function between the client's query/transaction processes and the Internet based data sources.

### BRIEF DESCRIPTION OF THE DRAWINGS

FIG. 1 is a schematic representation of High-Level Architecture for the invention.

FIG. 2 is a flow chart representation of steps for registering a merchant on the system.

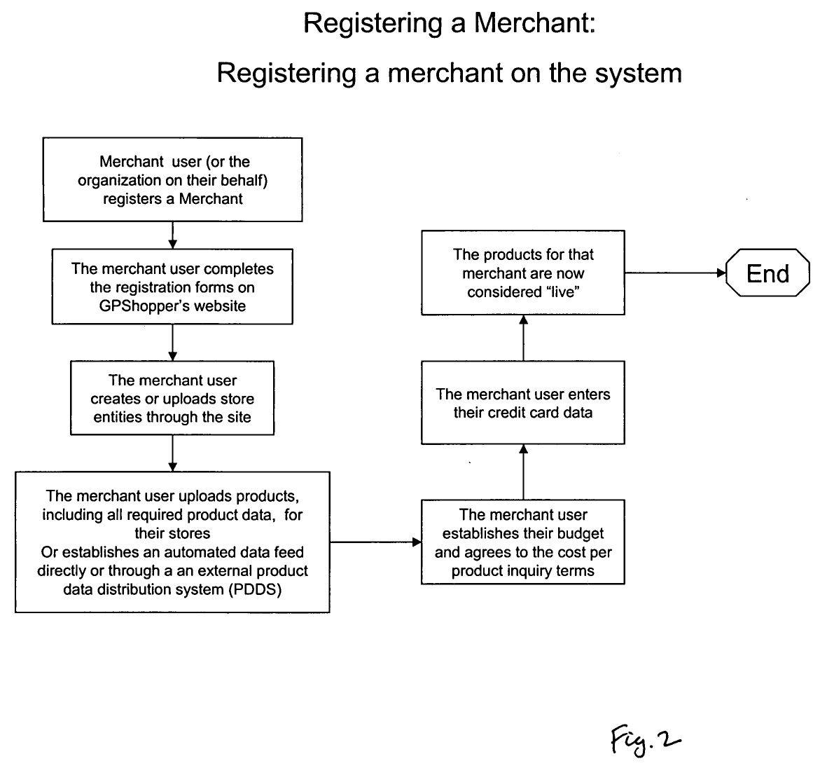

FIG. 3 is a flow chart representation of product data processing for configuring merchants and uploading product data.

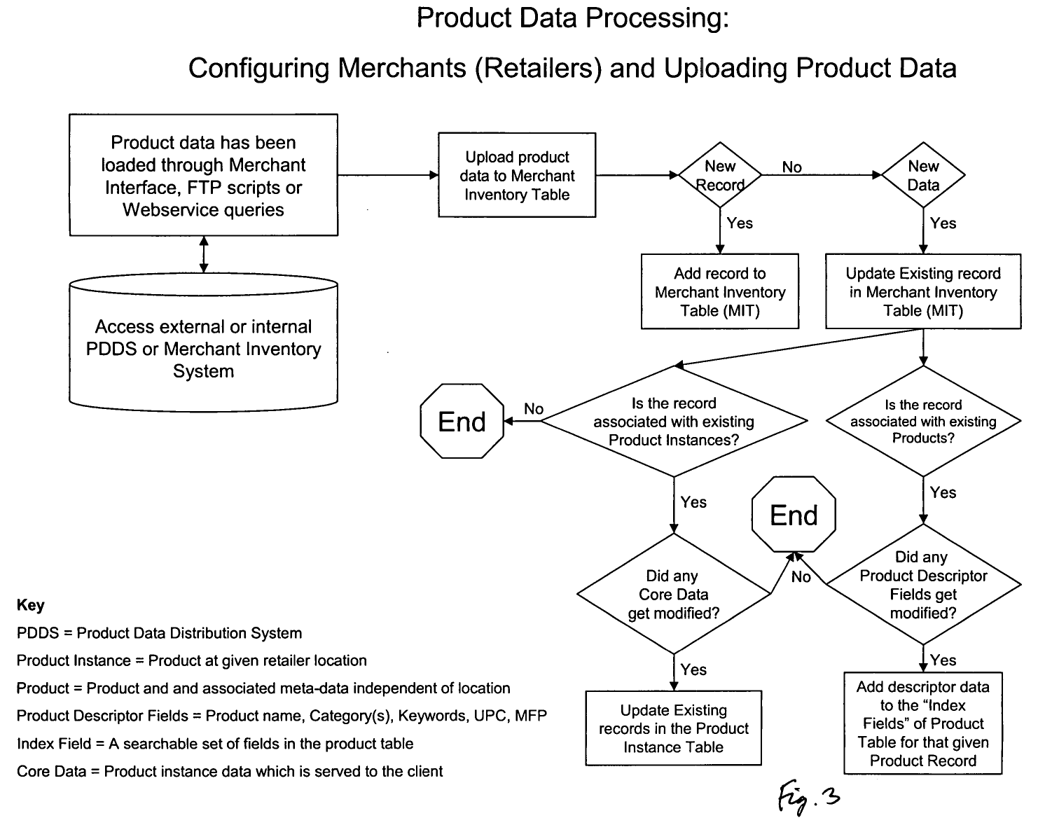

FIG. 4 is a flow chart representation of product data processing for updating a product table.

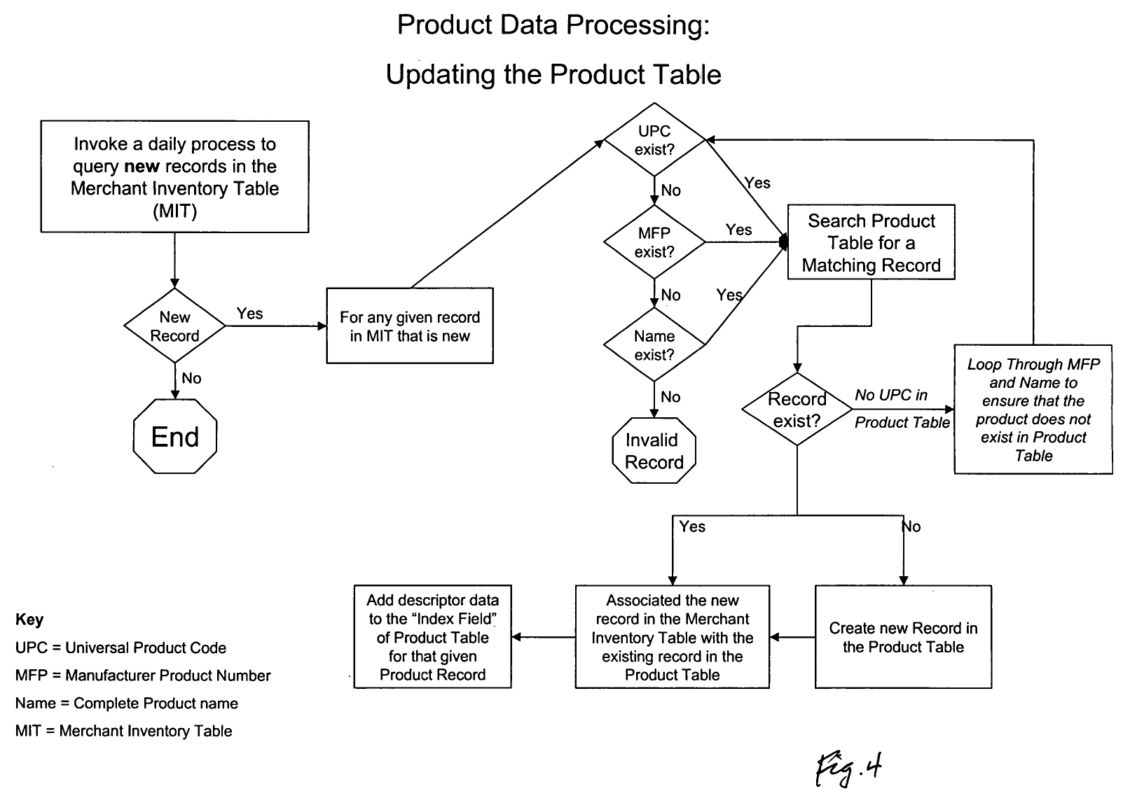

FIG. 5 is a flow chart representation of client query processing.

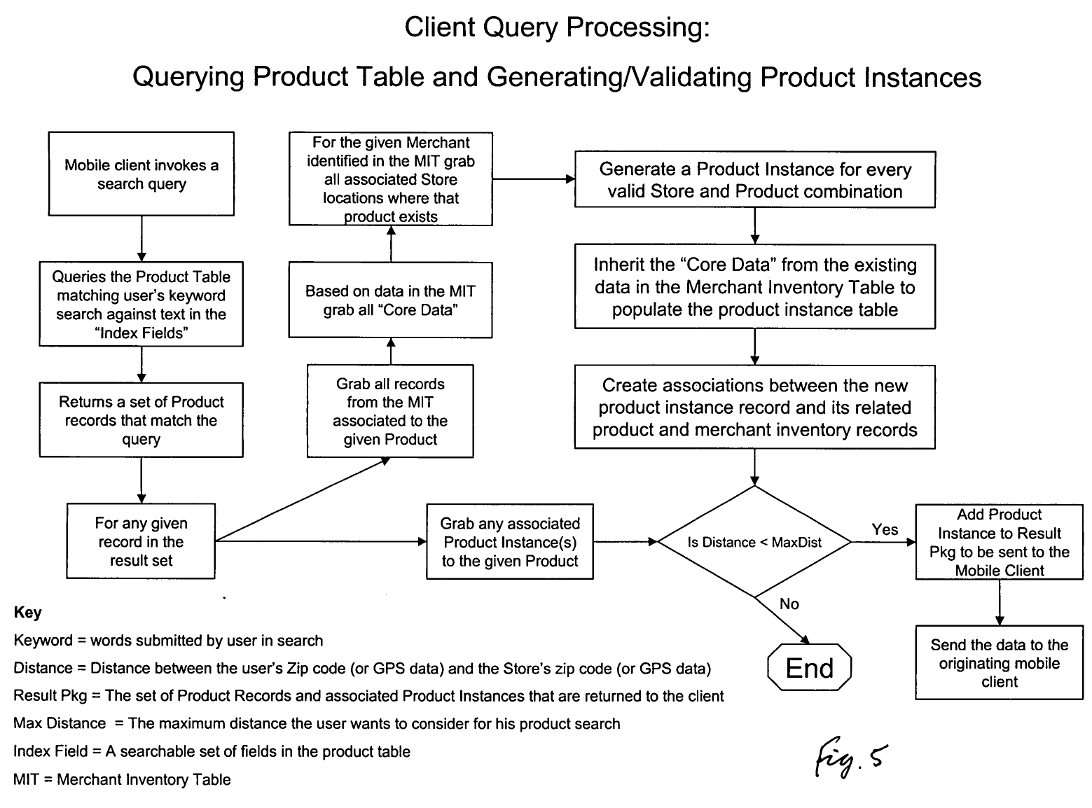

FIG. 6 is a flow chart representation of results processing for passing product results to the client and enabling user actions.

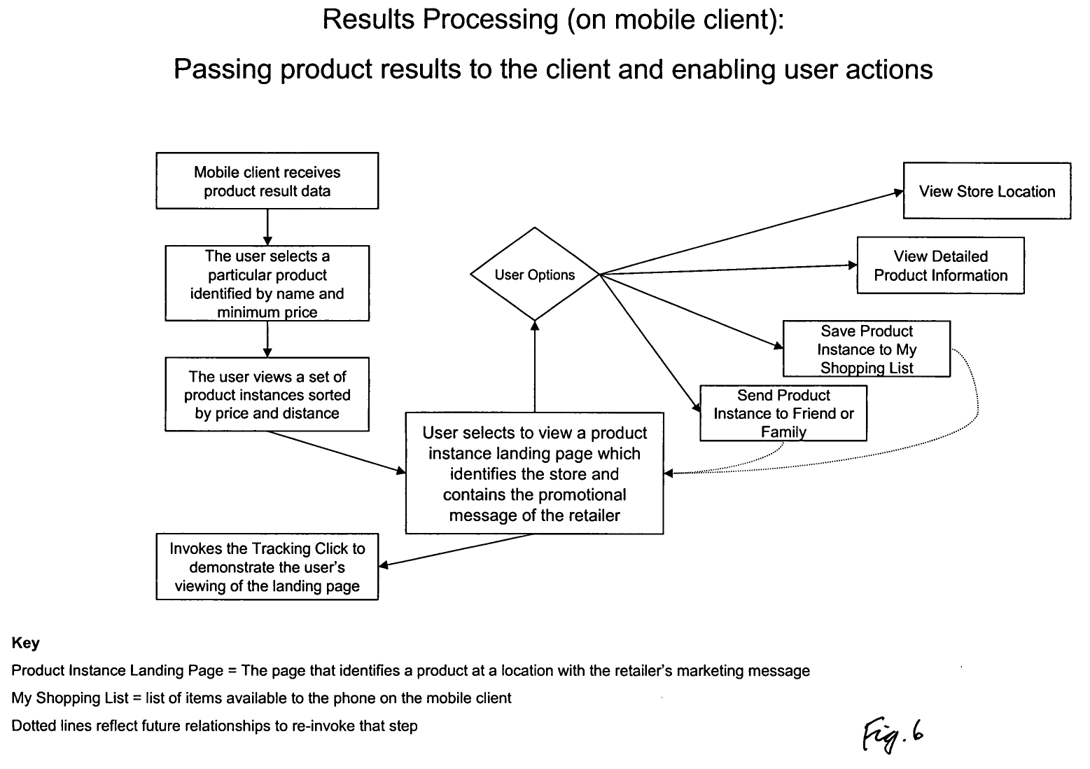

FIG. 7 is a flow chart representation of the processing for sending a product instance to a third party.

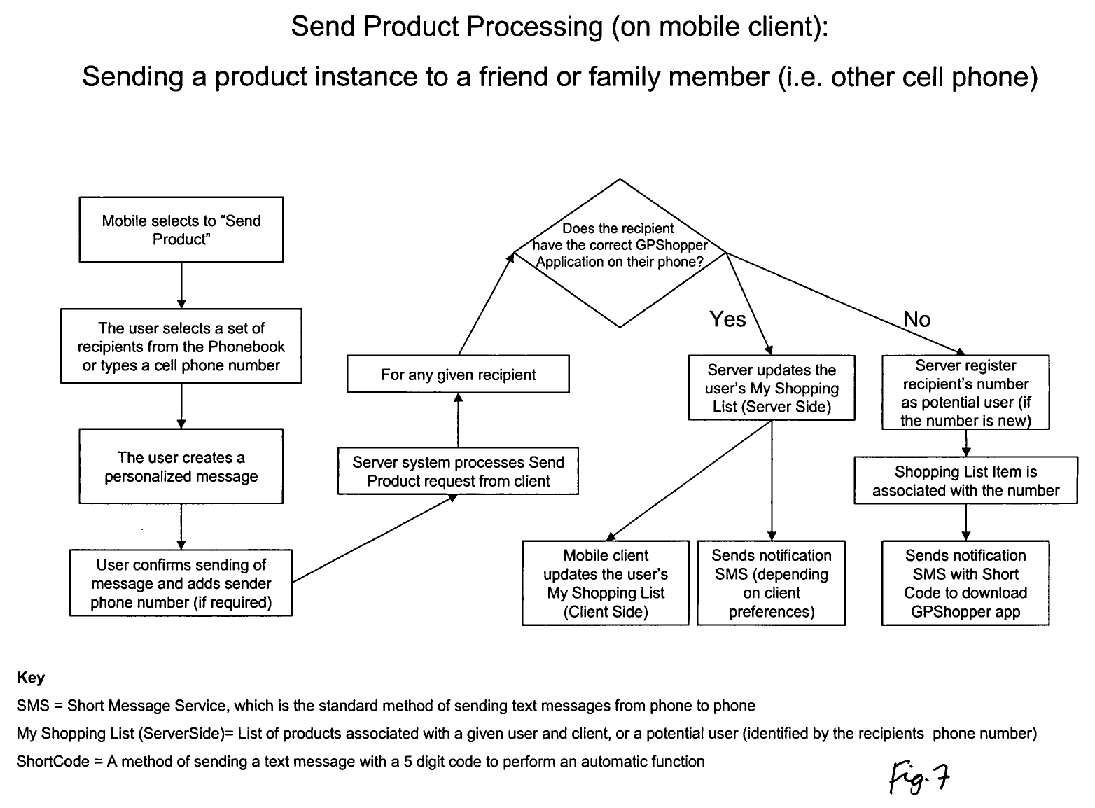

FIG. 8 is a flow chart representation for periodically processing and charging the merchant for clicks.

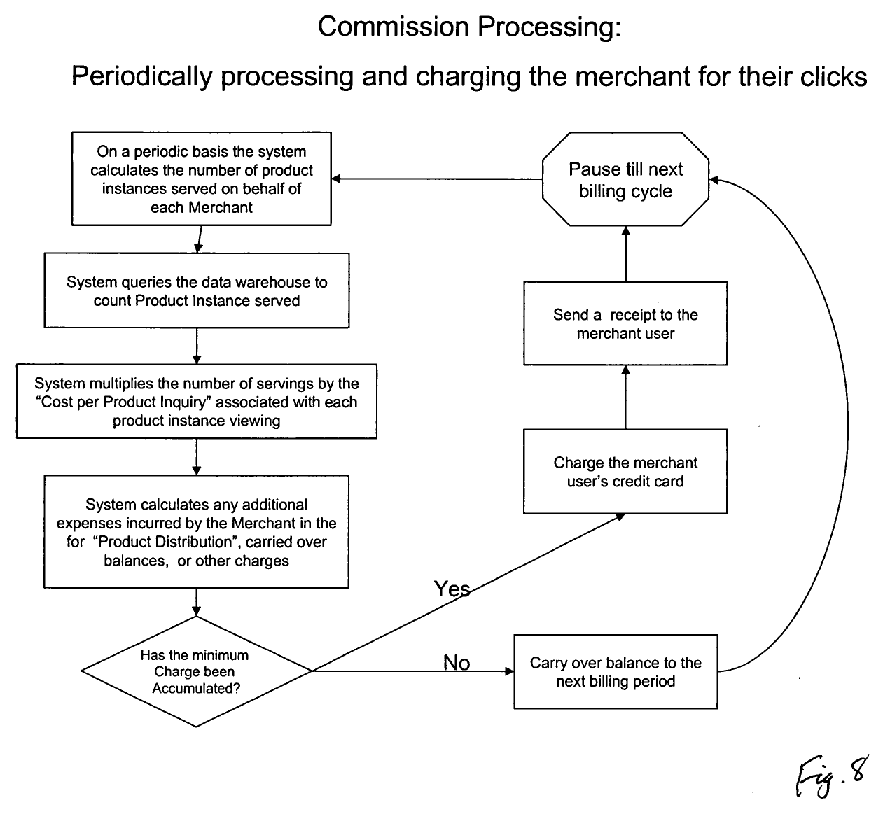

### DETAILED DESCRIPTION OF PREFERRED EMBODIMENTS OF THE INVENTION

One embodiment of the invention is a commissioning system that provided a representative of product information to a shopper having a cell phone and which credits commissions for activity by the shopper regarding the product. As used in this application, commissions is intended to be a broadly encompassing term that includes any form of payment or crediting and may be for example a fixed amount or a percentage of a profit earned by a merchant. The term “representative of product information” refers to a selection of product information or any information that is derived from the product information in order to present information that is more conveniently stored than the product information or which is better adapted for display on a mobile phone than the original product information that may have first been made available on a web page or on a database.

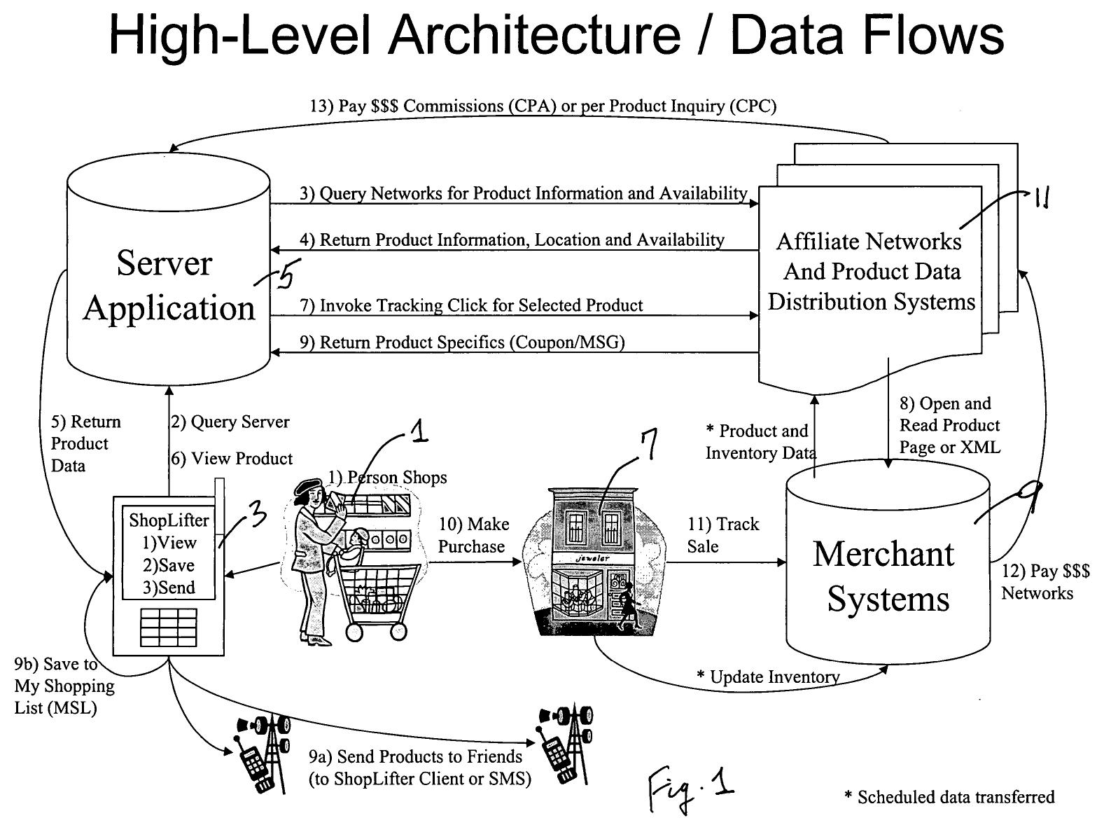

As shown in FIG. 1, a person, namely a shopper, indicated as 1 carries a mobile phone 3, which may be a cell phone, or other personal communication device capable of communicating with a server and displaying graphic information. A client application runs on the shopper's cell phone. A commissioning server 5 runs a server application and is adapted to communicate with the shopper's cell phone 3. When the shopper desires further information with regard to products, the shopper queries the commissioning server application on the server 5 for product information, and to view a representative of the product information.

The server application serves as a proxy between the end user's client application and the various Internet sources of data required to support the identified business processes. The server application will also store and track requests made by the client application for data mining, auditing, validation and other purposes. The server application will initiate, on behalf of the client, all “clicks” or “internet events” required to by affiliate marketing and merchants to ensure that the Merchants are compensating our organization based on valid activity. The server application will serve additional purposes in the future, such as, providing web-services interface to support OEM versions of the application, as well as allow end users to customize their use of their applications.

A typical merchant 7 maintains, or cooperate with a third party that maintains merchant systems 9 that maintain inventory information and track sales by the merchant to shoppers. The merchant system preferably may in turn communicate with affiliate networks and product data distribution systems (PDDS) 11 although that is not essential to the invention. The merchant system keeps the affiliate networks 11 advised of product and inventory data. In addition the affiliate networks 11 may provide the merchant systems 9 with product descriptions which will standardize product descriptions for different merchants and their different merchant systems 9. The PDDS may be internal to the commissioning server, for example where there is a direct business relationship between the merchant and the owner of the server application.

The client application may query the commissioning server 5 for product information. The server application running on the commissioning server then queries the product data distribution system 11 for product information. In response, the product data distribution system returns to the commissioning server 5 a representative of the requested product information. That representative may be any form of the data which is able to be handled by the server application. In view of the fact that the data is eventually going to be passed to the client application on the mobile phone 3 that representative data may be reduced in size and format, i.e. parsed, to that which is convenient for storage by the client application. In any event the commissioning server 5 returns to the client application a representative of the product information which may be the same as the representative that it received from the product data distribution system if that is already suitable for storage by the client application, or it may be reduced in size and format to that which is convenient for storage by the client application. In other words, there is a first and second creation of representatives of the product information which may be identical or which may reflect successive modifications of the product information. In the case where the original data is already suitable for display by the client application, both representatives may be the original data as stored on the product data distribution system 11.

When the shopper invokes the client application on the mobile phone 3 to view the representative of the product information, the client application informs the commissioning server 5. The commissioning server 5 then invokes a tracking click to the product data distribution system 11. The product data distribution system 11 then credits a payment, termed a first commission, to the commissioning system. In commissioning systems where a product distribution system is omitted, the tracking click may be served directly to the merchant system. The typical click is implemented by triggering a tracking URL with the appended user ID in the tracking code.

In this manner the purveyor of the commissioning system receives payments for specific interest expressed by the shopper in the product of particular merchants.

Alternatively the commissioning system may be arranged so that a second commission is earned when the shopper makes an actual purchase. In such a system, upon receipt of a tracking click, the product data distribution system 11 reads product information from the merchant system 9 and returns product specifics to the server application, and upon purchase by the shopper of the viewed product, the store advises the merchant system 9 and the merchant system provides information to the product data distribution system 11 to credit a second commission to the server application.

As a further alternative the two commissions can be credited to the server application without the product data distribution system 11 returning product specs to the server application.

As a further feature of the invention, upon the making of either an inquiry or purchase the server application may register the shopper by recording the shoppers unique i.d. such as a phone number upon execution of the client's request for information or purchase. In this way the interest of particular shoppers may be tracked. Such information may be useful to communicate withe purchaser either to promote further sales, to advise of related products or to correct errors that may occur in a purchase transaction, such as incorrect credit information. The shopper may also be provided by a merchant group with a private label version of the client software that is designed to block competitive information. For that use, the phone number of the shopper may be used to identify which information may be sent in response to queries from the shopper.

In a further alternative embodiment of the system the commission for viewing could be skipped and a payment, termed a commission whether based on a sales price or not, made upon purchase alone. In that case, the system skips the step of having the commissioning server 5 invoking a tracking click to the product data distribution system 11 upon viewing the representative of the product data, and the product data distribution system 11 then crediting the payment, termed a first commission, to the commissioning system.

In yet another embodiment of the commissioning system the product data distribution system, which is typically maintained by persons other than the merchant may be omitted and each of its functions handled by the merchant systems 9. In that case, the commissioning server, in response to a query from the client application, queries the merchant system for product information and returns a first representative of that information to the commissioning server, which returns to the client application a second representative of the information returned from the product data distribution system. Then, when the client application informs the commissioning server that it has viewed said second representative, the commissioning server invokes a tracking click to the merchant system, which credits a first commission to the commissioning system.

In a still further embodiment of the commissioning system where commission are earned both for viewing and for purchasing, the product data distribution system may be omitted and each of its functions handled by the merchant systems 9. In that embodiment, upon receipt of a tracking click, the merchant system returns product specifics to the server application, and when the shopper makes a purchase of the viewed product, the store advises the merchant system and the merchant system credits a second commission to the server application.

Another embodiment omitting the product data distribution system may provide commissions for viewing and purchasing without returning product specs to the server application.

Still another embodiment omitting the product data distribution system may provide a commission for purchasing regardless of whether there is a commission for viewing the representative of the product information.

Although each of the embodiments so far described were in terms of a single shopper seeking information about a single product, the system is adapted for use by multiple shoppers and by shoppers interested in multiple products. To facilitate the latter, the information requested by the shopper may be saved into a shopping list maintained on or at least accessible to the shopper's mobile phone.

In addition, in connection with each of the foregoing embodiments when the shopper has viewed product data he may invoke the client application to inform the server application to send all or a portion of the representative information to another shopper. In response, the server application invokes a tracking click for an additional commission to the server application. In this way the knowledge of one customer about the preferences of other potential customers is used to generate further sales and the server application is compensated for executing that referral. The other shopper need not be a single person. It may be a plurality of others chosen by the shopper from its address book which is stored on or accessible to the shopper's mobile phone.

Further embodiments may take advantage of cell phones having the ability to transmit their location. Such transmission may rely on GPS technology or the phone may indicate the identity of the cell with which it is currently in communication. In any event, where the location of the shopper's cell phone is known to the server application, the server application may be adapted to restrict to or emphasize product information at the shopper's local stores. In particular, the location of the shopper may be matched to locations of merchants having a desired product.

Still further modification of each of the foregoing embodiments may have the shopper specifying product information by selecting it from its shopping list. A still further embodiment may push product information onto the shopper's shopping list. This would occur when the shopper invokes its mobile phone to view product data so that the system does not generate unwanted mobile phone charges. In such a system, there is preferably a client application running on the shopper's cell phone that comprises a shopping list. When the commissioning server queries the product data distribution system for product information it pushes a representative of that information to the shopping list of the client application. Then when the client application informs the commissioning server it has viewed a representative of the product information pushed into its shopping list, the commissioning server invokes a tracking click to the product data distribution system, which credits a first commission to the commissioning system. In a still other embodiment, the commissioning server could enables a web service to push a representative of the information to the shopping list of the client application.

In any of the foregoing embodiments there could be multiple ways that the client application is adapted to search for products. For example the search could be by product category or product name.

In use of the invention the shopper would initiate the storage of the client application on a cell phone by navigating to and opening the application. He could then browse from a shopping list by opening My Shopping List and navigating to view a set of products. The client application enables searches by product name. This is implemented by opening a Product Search page, entering a search term, and viewing the results as a set of products. The system could also receive validate and execute the client request by querying the server for particular information such as category notes, store location, or product sets. The shopper is also enabled to configure acceptance rules for inbound product instances (i.e. a product at a particular retail location) to block spammed or unwanted product instances.

Browsing from the shoppers My Shopping List may be implemented. A predetermined number of products may be displayed together with indications of the source of the information. Such sources could be personal (stored by the shopper), from persons on the shopper's contact list, or promotional (from unknown sources). At the browsing stage the information provided does not contain complete product, store and price information, because it is necessary for the user to initiate a “click” so it can be registered that the user has chosen to see a product from a merchant. It that way advertisers will find demonstrated value in the system.

When the shopper sends product information to another shopper it may be accompanied by a message that explains features of the product or the reason the product information is being forwarded. Additionally, the message can also be a message sent by advertisers to promote their product. A merchant can also purchase the right to use a default message to accompany the product, if and only if, the sender did not type a message.

What is claimed is:

1. A commissioning system to provide a representative of product information to a shopper having a cell phone and to credit commissions for activity by the shopper regarding the product comprising:
a commissioning server running a server application,
a merchant system that tracks store inventory and sales to the shopper,
a product data distribution system for holding product and inventory data received from the merchant system,
a client application running on the shopper's cell phone for querying the commissioning server application for product information, and for viewing a representative of the product information,
wherein the commissioning server, in response to a query from the client application, queries the product data distribution system for product information and returns a first representative of that information to the commissioning server, which returns to the client application a second representative of the information returned from the product data distribution system,
wherein the client application informs the commissioning server when it has viewed said second representative, in response to which the commissioning server invokes a tracking click to the product data distribution system, which credits a first commission to the commissioning system.

2. The commissioning system of claim 1, wherein the second representative of the information is formed by parsing data from the first representative of the information.

3. The commissioning system of claim 1, wherein the second representative of the information is the same as the first representative of the information.

4. The commissioning system of claim 1, wherein upon receipt of a tracking click, the product data distribution system reads product information from the merchant system and returns product specifics to the server application, and
wherein upon purchase by the shopper of the viewed product, the store advises the merchant system and the merchant system provides information to the product data distribution system to credit a second commission to the server application.

5. The commissioning system of claim 1, wherein upon purchase by the shopper of the viewed product, the store advises the merchant system and the merchant system provides information to the product data distribution system to credit a second commission to the server application.

6. The commissioning system of claim 5, wherein the server application registers the shopper's unique i.d. upon execution of a client request.

7. A commissioning system to provide a representative of product information to a shopper having a cell phone and to credit commissions for activity by the shopper regarding the product comprising:
a commissioning server running a server application,
a merchant system that tracks store inventory and sales to the shopper,
a product data distribution system for holding product and inventory data received from the merchant system,
a client application running on the shopper's cell phone for querying the commissioning server application for product information, and for viewing a representative of the product information,
wherein the commissioning server, in response to a query from the client application, queries the product data distribution system for product information and returns a first representative of that information to the commissioning server, which returns to the client application a second representative of the information returned from the product data distribution system,
wherein upon purchase by the shopper of the viewed product, the store advises the merchant system and the merchant system provides information to the product data distribution system to credit a second commission to the server application.

8. A commissioning system to provide a representative of product information to a shopper having a cell phone and to credit commissions for activity by the shopper regarding the product comprising:
a commissioning server running a server application,
a merchant system that tracks store inventory and sales to the shopper and which holds product and inventory data,
a client application running on the shopper's cell phone for querying the commissioning server application for product information, and for viewing a representative of the product information,
wherein the commissioning server, in response to a query from the client application, queries the merchant system for product information and returns a first representative of that information to the commissioning server, which returns to the client application a second representative of the information returned from the product data distribution system,
wherein the client application informs the commissioning server when it has viewed said second representative, in response to which the commissioning server invokes a tracking click to the merchant system, which credits a first commission to the commissioning system.

9. The commissioning system of claim 8, wherein upon receipt of a tracking click, the merchant system returns product specifics to the server application, and
wherein upon purchase by the shopper of the viewed product, the store advises the merchant system and the merchant system credits a second commission to the server application.

10. The commissioning system of claim 8, wherein upon purchase by the shopper of the viewed product, the store advises the merchant system to credit a second commission to the server application.

11. A commissioning system to provide a representative of product information to a shopper having a cell phone and to credit commissions for activity by the shopper regarding the product comprising:
a commissioning server running a server application,
a merchant system that tracks store inventory and sales to the shopper and holds product and inventory data,
a client application running on the shopper's cell phone for querying the commissioning server application for product information, and for viewing a representative of the product information,
wherein the commissioning server, in response to a query from the client application, queries the merchant system for product information and returns a first representative of that information to the commissioning server, which returns to the client application a second representative of the information returned from the merchant system,
wherein upon purchase by the shopper of the viewed product, the store advises the merchant system and the merchant system credits a second commission to the server application.

12. The commissioning system of claim 1, wherein a portion of the second representative information is saved to a shopping list.

13. The commissioning system of claim 12, wherein the representative information is limited to a predetermined class of product instances selected by a third party engaged to private label the client application.

14. The commissioning system of claim 1, wherein the shopper informs the server application to send a portion of the second representative information to another shopper and the server application invokes a tracking click for a third commission to the server application.

15. The commissioning system of claim 14, wherein the another shopper is sent an SMS message with instructions to enable downloading of the client application.

16. The commissioning system of claim 14, wherein the another shopper is a plurality chosen by the shopper from its address book.

17. The commissioning system of claim 1, wherein the location of the shopper's cell phone is known to the server application, which is adapted to restrict product information to the shopper's local stores.

18. The commissioning system of claim 17, wherein the location of the shopper is matched to locations of merchants having the desired product.

19. The commissioning system of claim 13, wherein the product information is selected by the shopper from its shopping list.

20. A commissioning system to provide a representative of product information to a shopper having a cell phone and to credit commissions for activity by the shopper regarding the product comprising:
a commissioning server running a server application,
a merchant system that tracks store inventory and sales to the shopper,
a product data distribution system for holding product and inventory data received from the merchant system,
a client application running on the shopper's cell phone and comprising a shopping list, for querying the shopping list for product information, and for viewing a representative of the product information,
wherein the commissioning server queries the product data distribution system for product information and pushes a representative of that information to the shopping list of the client application,
wherein the client application informs the commissioning server when it has viewed said representative of the product information, in response to which the commissioning server invokes a tracking click to the product data distribution system, which credits a first commission to the commissioning system.

21. The commissioning system of claim 20, wherein the commissioning server enables a web service to push a representative of the information to the shopping list of the client application.

22. The commissioning system of claim 1, wherein the client application is adapted to search for products by an identifier selected from the group consisting of product name, UPC, manufacturer, MFP, product category and a distinctive keyword.

23. The commissioning system of claim 6 wherein the unique i.d. of the shopper is registered and is used to identify which information may be sent in response to queries from the shopper.
